(19) United States
(12) Patent Application Publication
(10) Pub. No.: US 2008/0298620 A1
(43) Pub. Date: Dec. 4, 2008

(54) Wearing hook with metal section for a hearing device

(76) Inventors: Wai Kit David Ho, Singapore (SG); Wee Haw Koo, Singapore (SG); Beng Hai Tan, Singapore (SG)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/156,595

(22) Filed: Jun. 2, 2008

(30) Foreign Application Priority Data
Jun. 4, 2007 (DE) 10 2007 025 976.1

(51) Int. Cl. H04R 25/02

(52) U.S. Cl. 381/330

(57) ABSTRACT

A wearing hook is provided for the behind-the-ear hearing device to improve acoustic stability. The wearing hook being composed of a metal part and a plastic part. The wearing hook is split substantially at a right angle to the sound channel, which runs along the inside of a wearing hook, into a first section and a second section. The first section, via which the wearing hook is mountable on the behind-the-ear hearing device, is substantially composed of a plastic. On the other hand the second section is substantially composed of a metal. The additional mass of the metal reduces the vibrations at the point of the wearing hook so that acoustic stability is improved.

### CROSS REFERENCE TO RELATED APPLICATIONS

This application claims priority of German application No. 10 2007 025 976.1 DE filed Jun. 4, 2007, which is incorporated by reference herein in its entirety.

### FIELD OF INVENTION

The present invention relates to a wearing hook for a behind-the-ear hearing device with a sound channel that runs along the inside of the wearing hook.

### BACKGROUND OF INVENTION

Hearing devices are wearable hearing apparatuses which are used to assist the hard-of-hearing. In order to accommodate numerous individual requirements, various types of hearing devices are available such as behind-the-ear (BTE) hearing devices and in-the-ear (ITE) hearing devices, for example also concha hearing devices or completely-in-the-canal (CIC) hearing devices. The hearing devices listed as examples are worn on the outer ear or in the auditory canal. Bone conduction hearing aids, implantable or vibrotactile hearing aids are also available on the market. The damaged hearing is thus stimulated either mechanically or electrically.

The key components of hearing devices are principally an input converter, an amplifier and an output converter. The input converter is normally a receiving transducer e.g. a microphone and/or an electromagnetic receiver, e.g. an induction coil. The output converter is most frequently realized as an electroacoustic converter e.g. a miniature loudspeaker, or as an electromechanical converter e.g. a bone conduction hearing aid. The amplifier is usually integrated into a signal processing unit. This basic configuration is illustrated in FIG. 1 using the example of a behind-the-ear hearing device. One or a plurality of microphones 2 for recording ambient sound are built into a hearing device housing 1 to be worn behind the ear. A signal processing unit 3 which is also integrated into the hearing device housing 1 processes and amplifies the microphone signals. The output signal for the signal processing unit 3 is transmitted to a loudspeaker or receiver 4, which outputs an acoustic signal. Sound is transmitted through a sound tube, which is fixed in the auditory canal by means of an otoplastic, to the device wearer's eardrum. Power for the hearing device and in particular for the signal processing unit 3 is supplied by means of a battery 5 which is also integrated in the hearing device housing 1.

A wearing hook is usually attached and/or screwed on to the housing of a BTE hearing device for wearing of the hearing device. A sound channel runs through the wearing hook along its curved form. A sound tube that transmits the output sound of the hearing device to the auditory canal is mounted on the point of the wearing hook.

### SUMMARY OF INVENTION

The sound generated by the receiver of the BTE hearing device and/or the receiver itself produces vibrations at the point of the wearing hook. Resonance vibrations may be stimulated at the point of the hook. These vibrations lead to undesired acoustic instabilities. Frequency responses with spurious peaks thus occur and in many cases there may be feedback that leads to unpleasant whistling.

A wearing hook for BTE hearing devices, which can easily be achieved in a form that is individually adjusted to the ear shape of the hearing device wearer, is known from the publication DE 298 19 415 U1. The curved wearing hook that is to hang over the ear is composed of a plastic in which a metal core is fused for plastic deformability. The wearing hook is permanently plastically deformable by means of the metal core. However other types of metal core can also be fused in plastic, such as metal tubes, goosenecks and such like.

A BTE hearing device having a housing and a hook-shaped part which is penetrated by a continuous channel is known from the publication DE 29 50 331. The hook-shaped part serves to conduct the sound to an ear adapter. For better frequency response the hook-shaped part is constructed such that the inner cross section increases in the direction that leads away from the housing.

The object of the present invention is to improve the acoustic properties of a wearing hook for a hearing device.

This object is inventively achieved by means of a wearing hook for a behind-the-ear hearing device with a sound channel that runs along the inside of the wearing hook, with the wearing hook being split, substantially at a right angle to the sound channel, into a first section and a second section, with the first section, by means of which the wearing hook is mountable on the behind-the-ear hearing device, being substantially composed of a plastic and with the second section being substantially composed of a metal.

The acoustic stability of the entire hearing device can advantageously thus be improved since the metal increases the mass of the wearing hook so that it resonates less, especially at its point. Thus the frequency response of the hearing device is influenced less by the wearing hook and the propensity for feedback is reduced.

The second section of the wearing hook preferably has a plastic coating and is thereby more resistant to corrosion.

The second section can be screwed on to the first section of the wearing hook. This allows for a stable connection to be produced between the two sections. However the plastic part can also be injection-molded or attached to the metal part.

According to a further preferred embodiment the length of the second section along the sound channel exceeds one third of the total length of the sound channel. As a rule a sufficient degree of acoustic stability can be achieved in this way. However the mass and thus the volume and/or the length of the metal section should generally be chosen so that the desired acoustic properties with regard to acoustic stability occur.

Furthermore it can be advantageous if a damping material is movably introduced into the sound channel of the second section. In this way the acoustic transmission function of the wearing hook can also be positively influenced with regard to acoustic stability.

### BRIEF DESCRIPTION OF THE DRAWINGS

The present invention is described in more detail with reference to the appended drawings, in which

FIG. 1 shows the basic configuration of a hearing device with its key components;

FIG. 2 shows a wearing hook according to a first embodiment of the present invention;

FIG. 3 shows the wearing hook of FIG. 2 with a damper in the metal section;

FIG. 4 shows the wearing hook of FIG. 3 with the damper in the mid-region of the metal section;

FIG. 5 shows the wearing hook of FIG. 3 with the damper at the proximal end of the metal section;

FIG. 6 shows a second embodiment of a wearing hook according to the invention;

FIG. 7 shows the first length of the metal section of a wearing hook;

FIG. 8 shows the second length of the metal section of a wearing hook; and

FIG. 9 shows the plastic part of the wearing hook of FIG. 6.

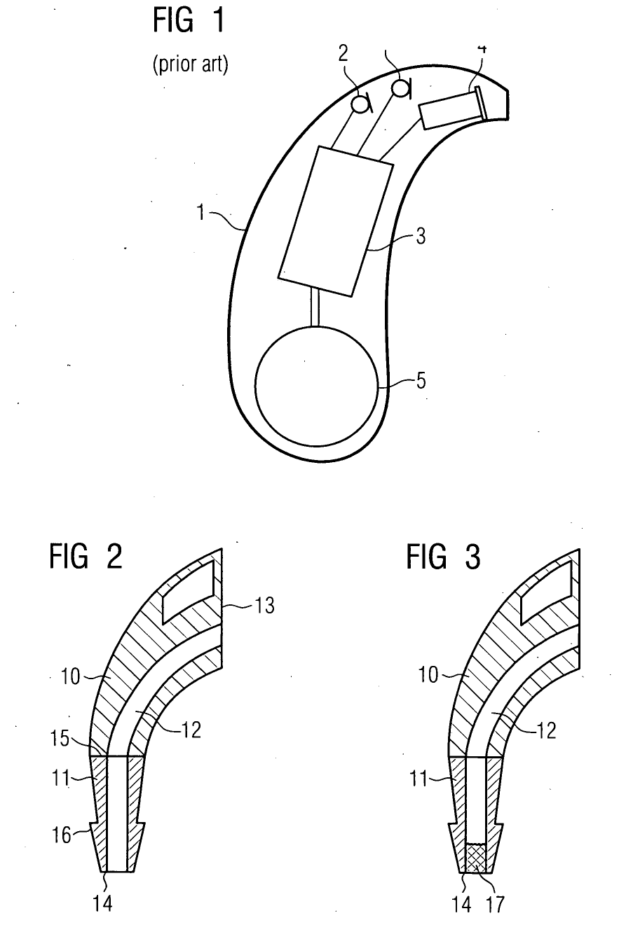

### DETAILED DESCRIPTION OF INVENTION

The exemplary embodiments shown in more detail below represent preferred embodiments of the present invention.

FIG. 2 shows a wearing hook with a plastic section 10 (first section) and a metal section 11 (second section). The two sections 10 and 11 are connected to each other such that a sound tube/sound channel 12 runs through them from end to end. It runs along the inside of the hook as shown by the longitudinal section of FIG. 2. The sound channel 12 also runs in a curve like the wearing hook itself.

The wearing hook tapers off from its proximal end 13, where it is affixed to the hearing device, to its distal end 14, from which the sound is released. This means that the plastic part 10 that is transverse to the sound channel 12 is larger on average than the metal section 11. In the example shown in FIG. 2 the separation between the metal section 11 and the plastic section 10 runs along a section plane 15 that is arranged perpendicularly to the sound channel 12.

The metal section 11 is provided with a circumferential barb 16 at its distal end 14. This ensures that a plastic tube sleeve can be affixed to the wearing hook in a mechanically fixed and acoustically isolated manner.

FIG. 3 shows the wearing hook from FIG. 2, with a damper 17 additionally being inserted into the sound channel 12 at the distal end 14. This screen damper provides acoustic resistance. It is composed of a plastic material with a specific mesh density that is selected in order to achieve the desired acoustic resistance.

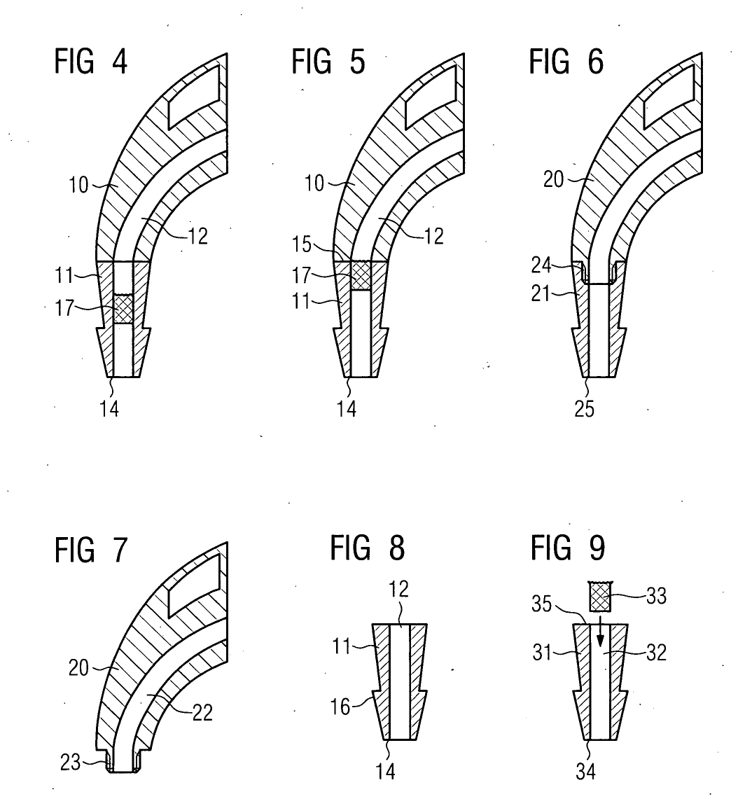

As the damper 17 is composed of plastic, it is difficult to fix it in a plastic hook since an adequate level of friction cannot generally be achieved. A further advantage of the metal section 11 also becomes evident here, namely the fact that adequate friction can be achieved between the plastic damper 17 and the interior metal surface of the metal section 11 in order to hold the damper permanently in the position shown in FIG. 4, for example. The damper is fixed here in the mid-region of the metal section 11 by means of friction. Depending on the desired acoustic transmission function of the wearing hook the damper 17 can also be positioned at other positions of the sound channel 12. Thus in the example of FIG. 5 the damper is positioned at the parting line 15 between the metal section 11 and the plastic section 10.

FIG. 6 shows a further embodiment of a wearing hook according to the invention. The plastic section 20 is essentially of the same type as the plastic section 10 of the previous exemplary embodiment shown in FIGS. 2 to 5. Here however the metal section 21 is screwed on to the plastic section 20. For this purpose the plastic half of the wearing hook or the plastic section 20 has on its distal end relative to the hearing device an external thread 23 that mates with the sound channel 22 as shown in FIG. 7. The metal section 21 has a corresponding internal thread 24. This screw coupling between the metal section 21 and the plastic section 20 provides for a firm engagement without play. Furthermore the metal section 21 can be repeatedly released from the plastic section 20 without causing any significant abrasive wear.

The main purpose of the metal section 21 on the wearing hook is to increase the mass at the point of the wearing hook, i.e. at its distal end 14, 25. In FIG. 8 the metal section 11 of FIG. 2 is shown without the plastic section 10. It has a specific length and runs along the sound channel 12. The length is selected as a function of the anatomical features of the ear of the wearer and as a function of the desired mass for vibration damping. If for reasons of acoustic stability it is necessary to increase the mass of the metal section, a correspondingly longer metal section 31 can be selected, as shown in FIG. 9. However the thickness of the wall of the metal piece 11 can also be varied in order to increase the mass. The mass of the metal section 11, 21, 31 can be influenced furthermore by the metal selected (steel, aluminum, etc.).

FIG. 9 also indicates that a cylinder-shaped plastic damper 33 can be inserted into the sound channel 32 of the metal section 31 there not from the distal end 34, but from the opposite end 35 that faces the plastic section (not shown). This damper can also be inserted into the metal section 11 of FIG. 8.

With the metal section 11, 21, 31 it is possible, in accordance with the invention, to ensure acoustic stability even in the case of hearing devices with a very high level of amplification. By contrast, in hearing devices with wearing hooks made solely of plastic, the only option is to reduce the level of amplification or to apply material to the wearing hook until its vibrations are reduced to a tolerable level. The metal half of the wearing hook also obviates the need to shape and/or dampen the acoustic transmission function of the sound tube so that there are no vibrations of the point of the hook. This is a time-consuming procedure, since an appropriate transmission function must be found separately for every length of a wearing hook.

1.-8. (canceled)

9. A wearing hook for a behind-the-ear hearing device, comprising:
a sound channel that runs along the inside of the wearing hook;
a first section composed of plastic; and
a second section composed of metal and has a plastic coating,
wherein the sound channel extends end to end through the two sections,
wherein a separation between the second section and the first section extends along a section plane arranged perpendicularly to the sound channel,
wherein the wearing hook is mountable on the behind-the-ear hearing device via the first section, and
wherein the length of the second section along the sound channel exceeds one third of the total length of the sound channel.

10. The wearing hook as claimed in claim 9, wherein the second section is screwed on to the first section.

11. The wearing hook as claimed in claim 9, further comprises a movable damping material arranged within the sound channel of the second section.

12. The wearing hook as claimed in claim 10, further comprises a movable damping material arranged within the sound channel of the second section.

13. A wearing hook for a behind-the-ear hearing device, comprising:
a sound channel extending along the inside of the wearing hook;
a first section composed of plastic; and
a second section composed of metal,
wherein the wearing hook is split at a right angle to the sound channel into the first and second sections,
wherein the sound channel extends through the two sections.

14. The wearing hook as claimed in claim 13, wherein the second section has a plastic coating.

15. The wearing hook as claimed in claim 13, wherein the second section is screwed on to the first section.

16. The wearing hook as claimed in claim 14, wherein the second section is screwed on to the first section.

17. The wearing hook as claimed in claim 13, wherein the length of the second section along the sound channel exceeds one third of the total length of the sound channel.

18. The wearing hook as claimed in claim 13, further comprises a movable damping material arranged within the sound channel of the second section.

19. The wearing hook as claimed in claim 17, further comprises a movable damping material arranged within the sound channel of the second section.
